(19) United States
(12) Patent Application Publication
(10) Pub. No.: US 2002/0071906 A1
(43) Pub. Date: Jun. 13, 2002

(54) Method and device for applying a coating

(76) Inventor: William P. Rusch, Ronkonkoma, NY (US)

Correspondence Address: Ira J. Schaefer, Esq., Clifford Chance Rogers & Wells LLp, 200 Park Avenue, New York, NY, 10166, US

(21) Appl. No.: 09/735,832

(22) Filed: Dec. 13, 2000

(51) Int. Cl. B05D 1/02; B05D 1/40

(52) U.S. Cl. 427/180

(57) ABSTRACT

An apparatus and method for applying a coating to an article uses a nozzle having a converging portion and a diverging portion downstream thereof forming a throat therebetween. A gas inlet is upstream of the converging portion of the nozzle for receiving a supply of high pressure gas and a powder inlet introduces a powdered feed material into a gas stream in the nozzle downstream of the throat. A gas heater heats the gas stream from the gas inlet upstream of the converging portion.

### BACKGROUND OF THE INVENTION

The present invention relates to a method and device for producing thermal sprayed coatings.

Methods and devices of this type are known from U.S. Pat. No. 5,302,414 directed to a gas dynamic spraying method for applying a coating. The contents of U.S. Pat. No. 5,302,414 are hereby incorporated by reference.

The present invention is an improvement on the method and apparatus shown in the aforementioned patent in order to lower the pressure required to introduce powder into a high pressure gas stream. Another purpose of the present invention is to deliver higher temperature gas to the nozzle resulting in less heat loss and higher gas velocities.

### SUMMARY OF THE INVENTION

In the method and apparatus of the aforementioned patent, a high pressure gas is provided to the inlet of a nozzle that has a converging portion followed by a diverging portion and forming a throat therebetween.

In accordance with the present invention, the objects of the present invention are achieved by injecting powder into the low pressure gas stream downstream from the nozzle throat.

In accordance with another embodiment of the present invention, a gas heater is incorporated into the thermal spray device upstream of the nozzle.

In a further embodiment of the present invention, the powder injection is at an angle to the longitudinal access of the nozzle, and in particular, at an acute angle. This angling of the powder injection reduces the wear on the nozzle.

### BRIEF DESCRIPTION OF THE DRAWINGS

FIG. 1 is a schematic of the device according to the invention.

### DETAILED DESCRIPTION OF THE INVENTION

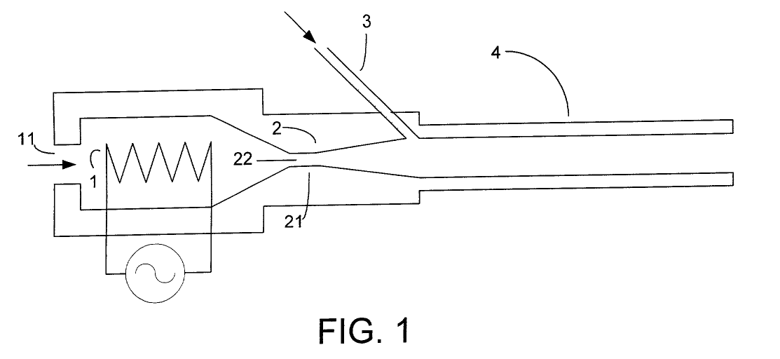

Referring now to FIG. 1, the device for applying a coating and for carrying out the method of the present invention comprises a gas heating section 1 having a high pressure gas inlet 11. The gas is inlet at a pressure of 250 to 600 PSI and preferably 500 PSI. The gas heating section has a heater that heats the cold gas from a temperature of from 0° C. to 300° C.

The heating section 1 is followed by the converging/diverging nozzle 2 that has a throat 21 with a straight section 22 between the converging and diverging portions of the nozzle. The length of the straight sections is 0.010″0 to 1.00″ inches long and preferably 0.020″ to . 100” inches long and has a diameter of 0.156″.

A powder inlet 3 feeds powdered material after throat section of the nozzle and is preferably at an acute angle to the longitudinal axis of the nozzle. The angle is preferably 20-80° and most preferably 45°. The nozzle further comprises an elongated duct 4 which confines the accelerating particles in the high velocity gas stream. The elongated duct is 1 to 12 inches long and more preferably 4 to 8 inches long and has a diameter of 0.343″.

As a result of these features, there is reduced pressure in the powder feeder, there is no wear in the converging/diverging nozzle and the device allows the use of high pressure gas with conventional and commercially available powder feeders.

What is claimed is:

1. An apparatus for applying a coating to an article comprising:
a nozzle having a converging portion and a diverging portion downstream thereof forming a throat therebetween;
a gas inlet upstream of the converging portion of said nozzle for receiving a supply of high pressure gas;
a powder inlet for introducing a powdered feed material into a gas stream in the nozzle downstream of the throat; and
a gas heater for heating the gas stream from the gas inlet upstream of the converging portion.

2. The apparatus of claim 1, wherein the nozzle further comprising an elongated duct downstream of the diverging portion of said nozzle and positioned parallel to a longitudinal axis of said nozzle.

3. The apparatus of claim 1, wherein said powder inlet is disposed at an acute angle to a longitudinal axis of the nozzle.

4. The apparatus of claim 1, wherein the nozzle throat comprises a straight section.

5. A method for applying a coating to an article, comprising the steps of:
streaming a high pressure gas at high velocity through a nozzle having a converging portion and a diverging portion downstream thereof forming a throat therebetween;
introducing powder into the gas stream in the nozzle downstream of the throat; and
heating the gas stream upstream of the converging portion.

6. The method of claim 5, wherein the step of introducing said powder comprises feeding the powder at an acute angle to a longitudinal axis of the nozzle.

7. The method of claim 1, further comprising passing the gas stream through an elongated duct downstream of the diverging portion.

8. The method of claim 1, wherein the throat comprises a straight section.
